(19) United States
(12) Patent Application Publication
(10) Pub. No.: US 2017/0131742 A1
(43) Pub. Date: May 11, 2017

(54) KEYBOARD AND ELECTRONIC DEVICE

(71) Applicant: Kabushiki Kaisha Toshiba, Tokyo (JP)

(72) Inventor: Tomoaki TAMURA, Kodaira Tokyo (JP)

(21) Appl. No.: 15/057,997

(22) Filed: Mar. 1, 2016

Related U.S. Application Data
(60) Provisional application No. 62/252,978, filed on Nov. 9, 2015.

(51) Int. Cl. G06F 1/16; H01H 13/70

(52) U.S. Cl. CPC G06F 1/1662; G06F 1/1616; H01H 13/70; H01H 2231/002

(57) ABSTRACT

In a keyboard according to an embodiment, a first end of a baseplate extends along a first direction. A second end of the baseplate extends along the first direction and is positioned opposite to the first end. A first cutout is disposed at the first end. A second cutout is disposed at the second end. The second cutout is aligned with the first cutout in a second direction with a partial offset in the first direction. The second direction intersects the first direction. A cover covers the baseplate. A third end of the cover extends along the first direction and is aligned with the first end in a third direction. The third direction intersects the first direction and the second direction. A fourth end of the cover extends along the first direction and is aligned with the second end in the third direction. The third end and the fourth end include the first hooks. A part of the first hook is positioned within the first cutout or the second cutout.

### CROSS-REFERENCE TO RELATED APPLICATIONS

This application is based upon and claims the benefit of priority from U.S. Provisional Application No. 62/252,978, filed on Nov. 9, 2015; the entire contents of which are incorporated herein by reference.

### FIELD

Embodiments described herein relate generally to a keyboard and an electronic device.

### BACKGROUND

Conventionally, there has been known an electronic device which comprises a housing equipped with a keyboard.

It is beneficial to obtain a keyboard which can reduce disadvantage such as a keyboard with a novel configuration in which the concentration of stress on the constituent elements is likely to be relieved.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a schematic and exemplary perspective view of an electronic device according to embodiments;

FIG. 2 is a schematic and exemplary perspective view of a housing in the state that a keyboard included in the electronic device are removed according to the embodiments;

FIG. 3 is a schematic and exemplary plan view of a keyboard according to a first embodiment;

FIG. 4 is a schematic and exemplary cross-sectional view illustrating a portion of IV-IV cross-section in FIG. 1;

FIG. 5 is schematic and exemplary plan view of a portion of the back face of the keyboard according to the first embodiment;

FIG. 6 is a schematic and exemplary perspective view of VI-VI cross-section illustrated in FIG. 3;

FIG. 7 is a schematic and exemplary plan view of a baseplate included in the keyboard according to the first embodiment;

FIG. 8 is a partially enlarged view of FIG. 7; and

FIG. 9 is a partially enlarged view of a baseplate that is included in a keyboard according to a second embodiment.

### DETAILED DESCRIPTION

Generally, according to an embodiment, a keyboard comprises, for example, a baseplate, a cover, and operable keys. The baseplate includes a first end and a second end. The first end extends along a first direction. The second end extends along the first direction and is positioned opposite to the first end. A first cutout is disposed at the first end. A second cutout is disposed at the second end. The second cutout is aligned with the first cutout in a second direction with a partial offset in the first direction. The second direction intersects the first direction. The cover covers the baseplate. The cover includes a third end and a fourth end. The third end extends along the first direction and is aligned with the first end in a third direction. The third direction intersects the first direction and the second direction. The fourth end extends along the first direction and is aligned with the second end in the third direction. The third end and the fourth end include first hooks. A part of the first hook is positioned within the first cutout or the second cutout.

Exemplary embodiments and modification examples of a keyboard and an electronic device are described below. In the embodiments described below, the technical features such as configurations and control as well as the working and effects attributed to the configurations and the control are only exemplary. In a plurality of embodiments described below, identical constituent elements are included. Hence, in the following explanation, identical constituent elements are referred to by the same reference numerals, and the redundant explanation is not repeated. In the accompanying drawings, for the purpose of illustration, the X direction, the Y direction, and the Z direction are illustrated. Herein, the X direction, the Y direction, and the Z direction are mutually orthogonal directions.

### First Embodiment

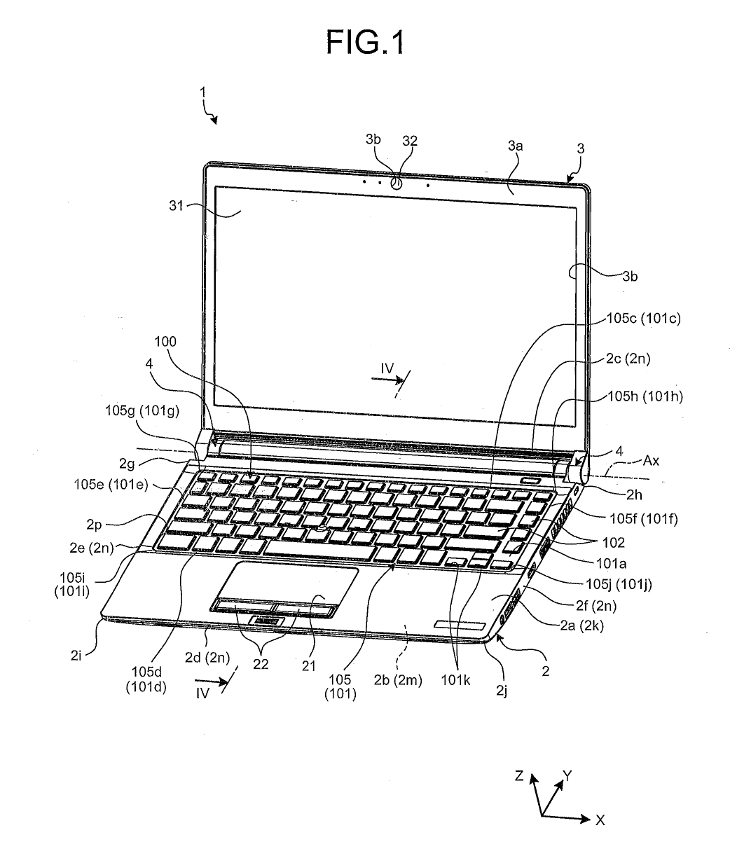

FIG. 1 is a perspective view of an electronic device 1. Herein, the electronic device 1 is a clamshell type or a notebook type personal computer. The electronic device 1 comprises a housing 2 and a housing 3. The housing 2 is equipped with a keyboard 100, a touchpad 21, and click buttons 22. The housing 3 is equipped with a display 31 and a camera 32. Herein, the display 31 and the camera 32 are housed in the housing 3. The housing 2 and the housing 3 are rotatably joined via a hinge 4. A rotation center Ax of the hinge 4 extends in the X direction. When the housing 2 and the housing 3 are rotated around the rotation center Ax of the hinge 4, the electronic device 1 can be changed in form between a usable state and a unusable state. In the usable state, the housing 2 and the housing 3 remain opened as illustrated in FIG. 1. In the unusable state, the housing 2 and the housing 3 are folded so as to overlap.

The housing 3 has a flat and cuboid exterior. An opening 3b is disposed on a face 3a of the housing 3. The display 31 and the camera 32 are exposed through the opening 3b.

The housing 2 has a flat and cuboid exterior. The housing 2 has a face 2a and a face 2b. The face 2a extends in the X direction and the Y direction. The face 2a is a flat, quadrilateral, and rectangular face. An opening 2p is disposed on the face 2a. The face 2a can be called a top face, an upper face, or an front face. The face 2a is a part of a wall 2k. The wall 2k can be called a top wall or an upper wall. The opening 2p is an example of a second opening.

The face 2b is positioned on the opposite side of the face 2a, and extends in the X direction and the Y direction. The face 2b is a flat, quadrilateral, and rectangular face. The face 2b can be called a bottom face, a lower face, or a back face. The face 2b is a part of a wall 2m. The wall 2m can be called a bottom wall or a lower wall.

The housing 2 includes four ends 2c to 2f and includes four corners 2g to 2j. The end 2c extends in the X direction. The end 2d is positioned opposite to the end 2c and extends in the X direction. The ends 2c and 2d can be called long sides. The end 2e extends in the Y direction. The end 2f is positioned opposite to the end 2e and extends in the Y direction. The ends 2e and 2f can be called short sides. The ends 2c to 2f can also be called sides or rims. The ends 2c to 2f are a part of a wall 2n. The wall 2n can be called a side wall or a peripheral wall. The corners 2g to 2j are disposed between two neighboring ends among the four ends 2c to 2f.

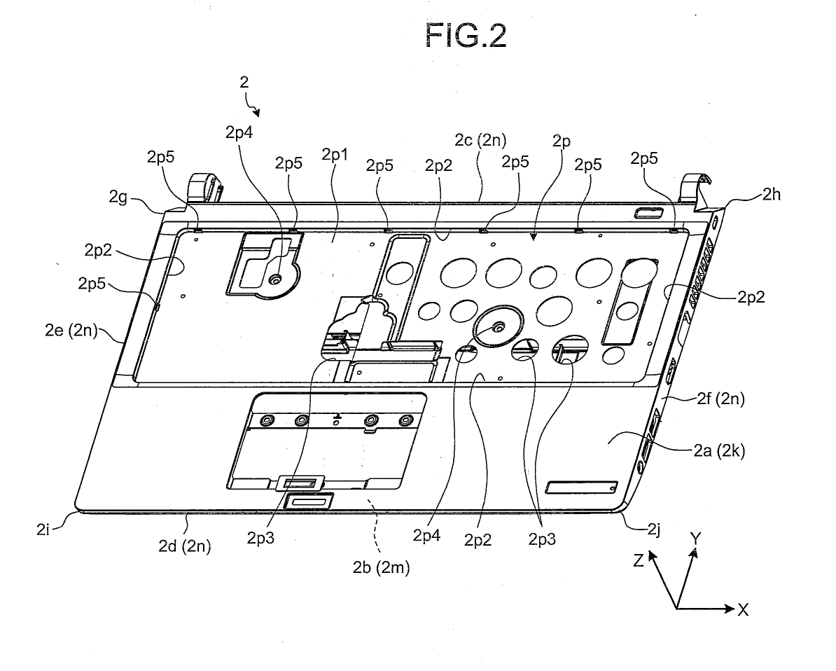

FIG. 2 is a perspective view of the housing 2 from which the keyboard 100 has been detached. As illustrated in FIG. 2, the opening 2p in which the keyboard 100 is installed is disposed as a depression on the face 2a. The shape of the opening 2p is quadrilateral when viewed in an orthogonal direction (opposite direction to the Z direction). The opening 2p is a relatively shallow depression having a smaller depth than the width of the rim thereof. The opening 2p is surrounded by a face 2p1, which is substantially parallel to the face 2a, and faces 2p2, which lie between the face 2a and the face 2p1. The face 2p1 extends along the X direction and the Y direction. The faces 2p2 extend along the X direction or the Y direction and along the Z direction. The face 2p1 can be called a bottom face. The faces 2p2 can be called lateral faces. At the faces 2p1 and 2p2, the wall 2k of the housing 2 is curved.

The level difference in the Z direction between the face 2a and the face 2p1, that is, the depth of the depression as the opening 2p is substantially equal to the height of the keyboard 100 or, specifically, the height from the bottom face (the back face) of the keyboard 100 to keys 102. Hence, while the keyboard 100 is installed in the opening 2p, there is no significant level difference between the top surface of the keys 102 and the face 2a.

Through holes 2p3 and 2p4 are disposed at the portion forming the face 2p1 in the wall 2k. Herein, a fastener such as a screw (not illustrated) is inserted through the through hole 2p4 from the back side of the wall 2k, that is, from the inside of the housing and is fastened with a female screw (not illustrated) disposed on the bottom face of the keyboard 100. As a result, the keyboard 100 is fixed to the housing 2.

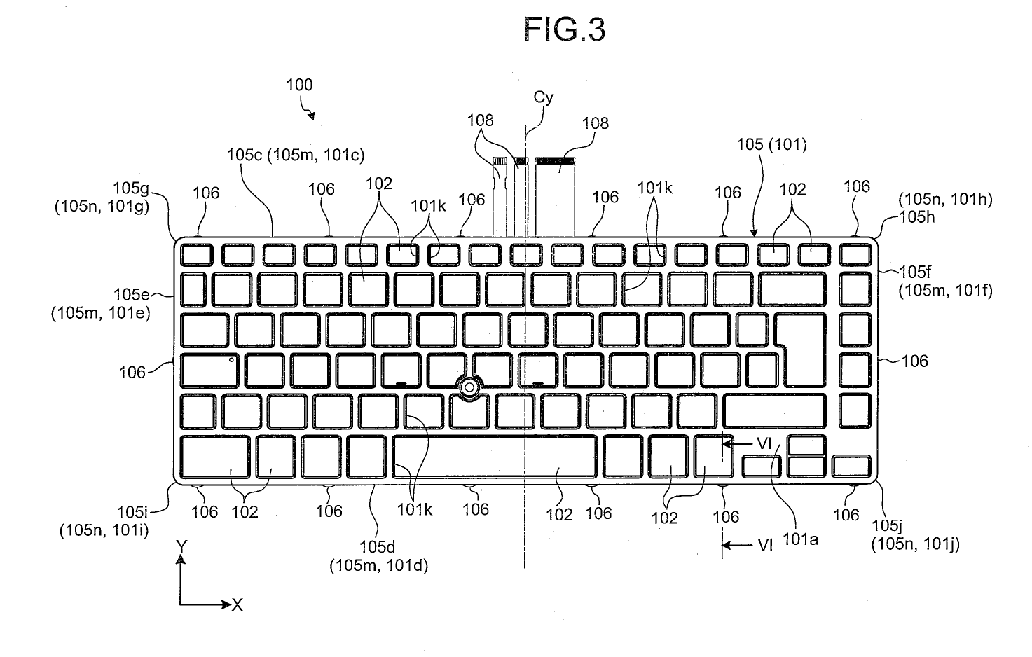

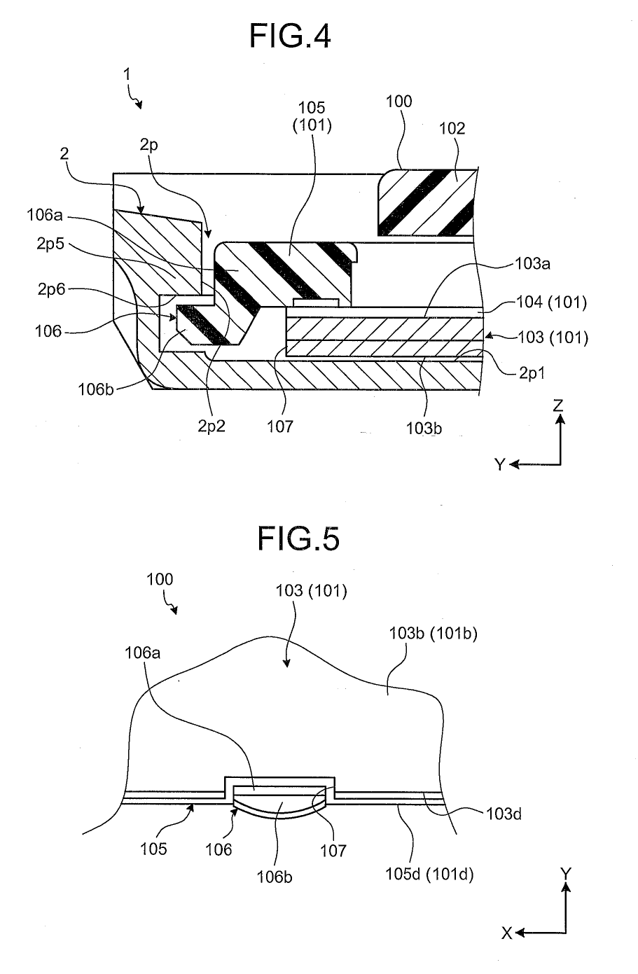

FIG. 3 is a plan view of the keyboard 100. FIG. 4 is a diagram illustrating a portion of IV-IV cross-section in FIG. 1. As illustrated in FIG. 3, hooks 106 are disposed on ends 101c to 101f of the keyboard 100. In the plan view illustrated in FIG. 3, the hooks 106 protrude from the ends 101c to 101f in the X direction or the Y direction. On the ends 101c and 101d, a plurality of hooks 106 is arranged at intervals. As illustrated in FIG. 2, on the rim of the opening 2p, hook portions 2p5 are disposed corresponding to the hooks 106. In FIG. 2, those hook portions 2p5 are illustrated that are disposed on the rim of the opening 2p on the side of the hinge 4. Besides, although not illustrated in FIG. 2, the hook portions 2p5 are disposed also on the rim of the opening 2p on the side near the palm rest. As illustrated in FIG. 4, the hook portion 2p5 of the keyboard 100 is formed, for example, as the rim of an opening 2p6 disposed on the face 2p2 of the wall 2k. In the state in which the hooks 106 and the hook portions 2p5 are hooked together, the keyboard 100 is installed in the housing 2. As a result of the hooks 106 and the hook portions 2p5 getting hooked, the rim of the keyboard 100 is prevented from lifting off in the direction away from the face 2a, and the keyboard 100 is prevented from moving in the X direction or the Y direction. Meanwhile. The hook portions 2p5 may be a protrusion such as a claw. The hook portion 2p5 is an example of a second hook.

As illustrated in FIG. 3, the keyboard 100 includes a base 101 and a plurality of keys 102. The base 101 has a flat and cuboid exterior extending in the X direction and the Y direction. The keyboard 100 includes a plurality of rows. The row includes a plurality of keys 102 arranged in the X direction. The keys 102 can be called key tops. On the base 101, either a plurality of openings 101k can be disposed through which each key 102 is exposed, or an opening can be disposed through which a plurality of keys 102 are exposed. Each key 102 is movably supported by the base 101 between a protruded position and a retracted position. The keys 102 are operated by the fingers of the user. The key 102 has an elastic member (not illustrated) such as a leaf spring, a coil spring, or elastomer. When pressed by the user, the keys 102 move from the protruded position to the retracted position. When released the press by the user, the keys 102 are pressed by the elastic member and move from the retracted position to the protruded position. The keyboard 100 sends electrical signals corresponding to the press-down operation of the keys 102 by the user, that is, sends electrical signals corresponding to the retracted position of the keys 102 to a control unit (not illustrated) of the electronic device 1. The keyboard 100 can be called an input device or an input unit.

FIG. 5 is a plan view of a part of the back face of the keyboard 100. The base 101 has a face 101a (see FIG. 3) and a face 101b (see FIG. 5). The face 101a extends in the X direction and the Y direction. The face 101b is positioned opposite to the face 101a. The face 101a is a flat, quadrilateral, and rectangular face. The openings 101k are disposed on the face 101a. The face 101a can be called a top face, an upper face, or an front face. The face 101b can be called a bottom face, a lower face, or a back face.

The base 101 includes four ends 101c to 101f and includes four corners 101g to 101j. The end 101c extends in the X direction. The end 101d is positioned opposite to the end 101c and extends in the X direction. The ends 101c and 101d can be called long sides. The end 101e extends in the Y direction. The end 101f is positioned opposite to the end 101e and extends in the Y direction. The ends 101e and 101f can be called short sides. The ends 101c to 101f can also be called sides or rims. Each of the corners 101g to 101j is disposed between two neighboring ends among the four ends 101c to 101f. The ends 101c to 101f of the base 101 are also the ends of the keyboard 100. The corners 101g to 101j of the base 101 are also the corners of the keyboard 100. The X direction is an example of a first direction, the Y direction is an example of a second direction.

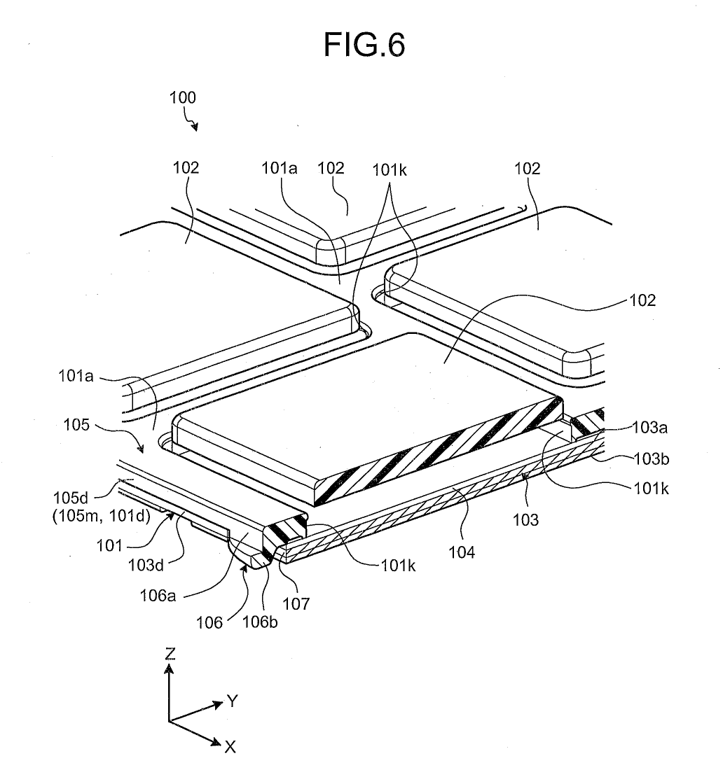

FIG. 6 is a perspective view of VI-VI cross-section illustrated in FIG. 3. As illustrated in FIG. 6, the base 101 includes a baseplate 103, a circuit board 104, and a cover 105. The baseplate 103 is covered by the cover 105. The circuit board 104 is positioned between the baseplate 103 and the cover 105. The baseplate 103, the circuit board 104, and the cover 105 are arranged in this order in the Z direction. That is, the baseplate 103 is covered by the cover 105, and the circuit board 104 is positioned between the baseplate 103 and the cover 105. Herein, the Z direction is an example of a third direction.

The keys 102 on the circuit board 104 are positioned opposite to the baseplate 103. The keys 102 are exposed through the openings 101k disposed on the cover 105. When the key 102 is pressed in the opposite direction to the Z direction, switch that is disposed on the circuit board 104 corresponding to the key 102 is closed, and electrical signal corresponding to the concerned key 102 flow in the circuit board 104. In other words, electrical signal corresponding to the key 102 is sent from the circuit board 104 to the control unit (not illustrated) of the electronic device 1. Other elements such as support mechanisms for the keys 102 are disposed between the keys 102 and the circuit board 104

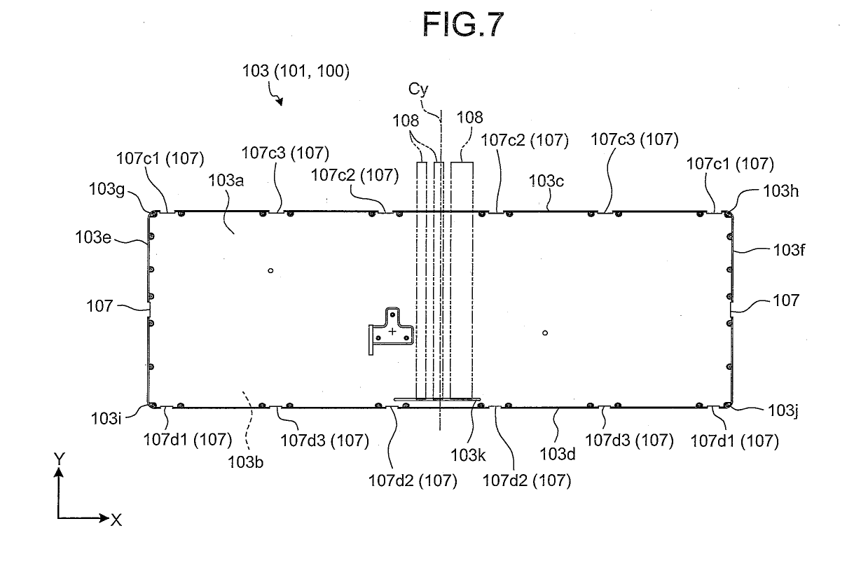

FIG. 7 is a plan view of the baseplate 103. As illustrated in FIG. 7, the baseplate 103 has a flat and rectangular plate-like exterior extending in the X direction and the Y direction. The baseplate 103 is a member for supporting the elements inside the base 101. Thus, the baseplate 103 can be called a support member.

The baseplate 103 includes four ends 103c to 103f and includes four corners 103g to 103j. The end 103c extends in the X direction. The end 103d is positioned on the opposite side of the end 103c and extends in the X direction. The ends 103c and 103d can be called long sides. The end 103e extends in the Y direction. The end 103f is positioned opposite to the end 103e and extends in the Y direction. The ends 103e and 103f can be called short sides. The ends 103c to 103f can be called sides or rims. Each of the corners 103g to 103j is disposed between two neighboring ends among the four ends 103c to 103f. The end 103c is an example of a first end. The end 103d is an example of a second end. The end 103e is an example of a fifth end. The end 103f is an example of a sixth end.

The circuit board 104 illustrated in FIG. 6 has a flat and rectangular film-like exterior extending in the X direction and the Y direction. The circuit board 104 includes wiring (not illustrated) and a switch (not illustrated) corresponding to each of plural keys 102. The circuit board 104 can be called a membrane, for example.

The cover 105 illustrated in FIG. 6 has a flat and cuboid case-like exterior extending in the X direction and the Y direction. The cover 105 covers the baseplate 103, the circuit board 104, and the support mechanism (not illustrated) for the keys 102. The baseplate 103, the circuit board 104, and the cover 105 can be integrated at a plurality of locations with fasteners such as screws (not illustrated), a snap-fit mechanism, or an adhesion layer.

As illustrated in FIG. 3, the cover 105 includes four ends 105c to 105f and includes four corners 105g to 105j. The end 105c extends in the X direction. The end 105d is positioned on the opposite side of the end 105c and extends in the X direction. The ends 105c and 105d can be called long sides. The end 105e extends in the Y direction. The end portion 105f is positioned on the opposite side of the end 105e and extends in the Y direction. The ends 105e and 105f can be called short sides. The ends 105c to 105f can also be called sides or rims. In the first embodiment, the ends 105c to 105f have a belt-like flat face 105m. Alternatively, without having the flat face 105m, the ends 105c to 105f can be chamfered or can protrude as curved faces. As illustrated in FIG. 6, the end 105d is aligned with the end 103d of the baseplate 103 in the Z direction. Likewise, the ends 105c, 105e, and 105f are each aligned with the ends 103c, 103e, and 103f, of the baseplate 103 in the Z direction. The end 105c is an example of a third end, the end 105d is an example of a fourth end.

As illustrated in FIG. 3, each of the corners 105g to 105j is disposed between two neighboring ends among the four ends 105c to 105f. The corners 105g to 105j have a curved face 105n continuous with the face 105m and including a generating line along the Z direction. That is, in the view of FIG. 3, the corners 105g to 105j are chamfered so as to protrude as curves. Alternatively, the corners 105g to 105j can be chamfered spherically.[0029]

As illustrated in FIG. 6, the hooks 106 are disposed on the cover 105. That is, the hooks are disposed on the ends 105c to 105f of the cover 105. As illustrated in FIGS. 5 and 6, the hook 106 passes through cutout 107 disposed on the baseplate 103. That is, the hook 106 is partially positioned within the cutout 107. The hook 106 includes an arm 106a and a claw 106b. The arms 106a is belt-like or strip-like in shape, and extends from the ends 105c to 105f of the cover 105 in the opposite direction to the Z direction. The claw 106b protrudes along the X direction or the Y direction from a tip of the arm 106a. The tip of the arm 106a is an end of the arm 106a in the opposite direction to the Z direction. That is, the tip of the arm 106a is curved at a substantially right angle. The tip of the arm 106a and the claw 106b are positioned inside the cutout 107 disposed on the baseplate 103. In other words, the tip of the arm 106a and the claw 106b are housed in the cutout 107. Herein, the cutout 107 serve as clearances formed to avoid interference between the hooks 106 and the baseplate 103. The hook 106 is an example of a first hook.

As illustrated in FIG. 7, the cutouts 107 are disposed on the ends 103c to 103f of the baseplate 103. In the plan view along the Z direction or along the opposite direction, the cutouts 107 have a quadrilateral shape. The cutouts 107 disposed on the end 103c of the baseplate 103 include cutouts 107c1, 107c2, and 107c3. The cutouts 107 disposed on the end 103d of the baseplate 103 include cutouts 107d1, 107d2, and 107d3. The cutouts 107c1, 107c2, and 107c3 are examples of first cutouts. The cutouts 107d1, 107d2, and 107d3 are examples of second cutouts.[0031] The cutouts 107c1 are positioned closer to the ends 103e and 103f than to a center line Cy along the Y direction of the keyboard 100. The cutouts 107c1 are positioned at the corners 103g and 103h of the baseplate 103. The cutouts 107 include two cutouts 107c1. One of the two cutouts 107c1 is positioned away from the center line Cy in the X direction while the other cutout 107c1 is positioned away from the center line Cy in the opposite direction to the X direction. For example, the two cutouts 107c1 are arranged symmetrically with respect to the center line Cy.

The cutouts 107c2 are positioned closer to the center line Cy of the keyboard 100 than to the ends 103e and 103f. The cutouts 107 include two cutouts 107c2. One of the two cutouts 107c2 is positioned away from the center line Cy in the X direction while the other cutout 107c2 is positioned away from the center line Cy in the opposite direction to the X direction. For example, the two cutouts 107c2 are arranged symmetrically with respect to the center line Cy.

The cutout 107c3 is disposed on the end 103c and is positioned between a pair of the cutouts 107c1 and 107c2. The cutouts 107 include two cutouts 107c3. One of the two cutouts 107c3 is positioned away from the center line Cy in the X direction while the other cutout 107c3 is positioned away from the center line Cy in the opposite direction to the X direction. For example, the two cutouts 107c3 are arranged symmetrically with respect to the center line Cy.

The cutouts 107d1 are positioned closer to the ends 103e and 103f than to the center line Cy of the keyboard 100. The cutouts 107d1 are positioned at the corners 103i and 103j of the baseplate 103. The cutouts 107 include two cutouts 107d1. One of the two cutouts 107d1 is positioned away from the center line Cy in the X direction while the other cutout 107d1 is positioned away from the center line Cy in the opposite direction to the X direction. For example, the two cutouts 107d1 are arranged symmetrically with respect to the center line Cy. The cutouts 107d1 are examples of third cutouts.

The cutouts 107d2 are positioned closer to the center line Cy of the keyboard 100 than to the ends 103e and 103f. The cutouts 107 include two cutouts 107d2. One of the two cutouts 107d2 is positioned away from the center line Cy in the X direction while the other cutout 107d2 is positioned away from the center line Cy in the opposite direction to the X direction. For example, the two cutouts 107d2 are positioned symmetrically with respect to the center line Cy. The cutouts 107d2 are examples of fourth cutouts.

The cutout 107d3 is disposed on the end 103d and is positioned between a pair of the cutouts 107d1 and 107d2. The cutouts 107 include two cutouts 107d3. One of the two cutouts 107d3 is positioned away from the center line Cy in the X direction while the other cutout 107d3 is positioned away from the center line Cy in the opposite direction to the X direction. For example, the two cutouts 107d3 are positioned symmetrically with respect to the center line Cy.

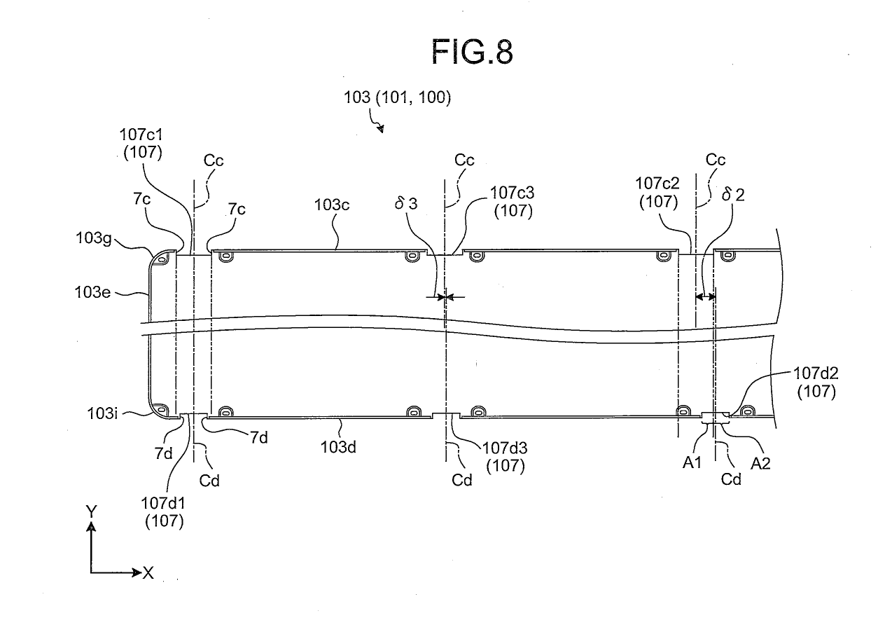

FIG. 8 is a partially enlarged view of FIG. 7. As illustrated in FIG. 8, the cutout 107d2 is aligned with the cutout 107c2 in the Y direction, with a partial offset δ2 in the X direction. The cutout 107d3 is aligned with the cutout 107c3 in the Y direction, with a partial offset 53 in the X direction. In other words, the cutout 107d2 is across, in the Y direction, (the baseplate 103) from the cutout 107c2, and the cutout 107d2 is slightly offset from the cutout 107c2 in the X direction. The cutout 107d3 is across, in the Y direction, (the baseplate 103) from the cutout 107c3, and the cutout 107d3 is slightly offset from the cutout 107c3 in the X direction. In other words, the cutout 107d2 is positioned opposite to the cutout 107c2 in the Y direction with the partial offset δ2 in the X direction. The cutout 107d3 is positioned opposite to the cutout 107c3 in the Y direction with the partial offset 53 in the X direction.

As illustrated in FIG. 8, the cutout 107d2 includes a first area A1 and a second area A2. The first area A1 and the second area A2 are adjacent in the X direction and are continuous with each other. The first area A1 is aligned with the cutout 107c2 in the opposite direction to the Y direction. The second area A2 is offset from a position in the X direction, the position is opposite to the cutout 107c2 in the opposite direction to the Y direction. For example, a center line Cc extending along the Y direction and passing through the center of the cutout 107c2 in the X direction, and a center line Cd extending along the Y direction and passing through the center of the cutoff 107d2 in the X direction, have a difference equal to the partial offset δ2. Although not illustrated in FIG. 8, the cutout 107d3 also includes the first area and the second area.

The center line Cd (the center in the X direction) of the cutout 107d1 is approximately aligned in the Y direction with the center line Cc (the center in the X direction) of the cutout 107c1. However, edges 7d of the cutout 107d1 are out of alignment with edges 7c of the cutout 107c1 in the Y direction. The edges 7d of the cutout 107d1 are the edges in the X direction and the opposite direction of the X direction. The edges 7c of the cutout 107c1 are the edges in the X direction and the opposite direction of the X direction. The edges 7d have a slight offset with edges 7c in the X direction. The cutout 107d1 is an example of a fifth cutout.

As apparent from FIG. 8, the offset δ3 between the cutout 107c3 and the cutout 107d3 in the X direction is greater than the offset δ1 (=0, not illustrated in FIG. 8) between the cutout 107c1 and the cutout 107d1 in the X direction. Moreover, the offset δ2 between the cutout 107c2 and the cutout 107d2 in the X direction is greater than the offset δ3 between the cutout 107c3 and the cutout 107d3 in the X direction.

As illustrated in FIGS. 3 and 7, the keyboard 100 includes a wiring unit 108. The conductor in the circuit board 104 and the conductor in the housing 2 and the housing 3 are electrically connected by the wiring unit 108. The wiring unit 108 passes through an opening 103k disposed on the baseplate 103. The wiring unit 108 is configured to be belt-like and film-like in shape. For example, the wiring unit 108 is a flexible printed circuits (FPC). The wiring unit 108 extends along the Y direction while the faces thereof lie along a face 103b of the baseplate 103, that is, along the face 101b of the base 101. The wiring unit 108 passes along the Y direction between the two cutouts 107c2, that is, between the hooks 106 (not illustrated in FIGS. 3 and 7) in the two cutouts 107c2, and protrudes toward the outside of the base 101 in the plan view illustrated in FIGS. 3 and 7. Because of such a configuration, it becomes possible to avoid interference between the wiring unit 108 and the hooks 106. The opening 103k is an example of a first opening.

As described above, in the keyboard 100, the cutouts 107d2 are aligned with the cutouts 107c2 in the Y direction, with the partial offset δ2 in the X direction. Moreover, the cutouts 107d3 are aligned with the cutouts 107c3 in the Y direction, with the partial offset δ3 in the X direction. Hence, for example, in case the keyboard 100 is deformed by an external force or heat and in case the faces 101a and 101b of the base 101 are warped, that is, in case the faces 101a and 101b are warped concavely or convexly in the state that the central part in the X direction of the baseplate 103 and the ends 103e and 103f are separated away in the Z direction, the concentration of stress in the vicinity of the cutouts 107c2, 107c3, 107d2, and 107d3 of the baseplate 103 can be relieved unlike the configuration in which the cutouts disposed on the end 103c and the cutouts disposed on the end 103d are aligned in the Y direction with no offset therebetween in the X direction.

Meanwhile, the further the cutouts 107c1 and 107d1 are away from the corners 103g to 103j, the more easily the corners 103g to 103j lift off the housing 2. In this regard, in the keyboard 100, the nearer to the corners 103g to 103j the partial offsets δ1 (not illustrated), δ2, and δ3 are, the smaller the partial offsets δ1, δ2, and δ3 are. The partial offsets δ1, δ2, and δ3 are the offsets between the cutouts 107c1, 107c2, and 107c3 and the cutouts 107d1, 107d2, and 107d3 arranged in the Y direction. Hence, the cutouts 107c1 and 107d1 can be positioned closer to the corners 103g to 103j. Thereby, the corners 103g to 103j are unlikely to lift off the housing 2.

In the keyboard 100, although the cutouts 107d1 are aligned with the cutouts 107c1 in the Y direction, the edges 7d of the cutouts 107d1 in the X direction are not aligned in the Y direction with the edges 7c of the cutouts 107c1 in the X direction. Hence, for example, in case the keyboard 100 is deformed by an external force or heat and in case the faces 101a and 101b of the base 101 are warped, the concentration of stress in the vicinity of the cutouts 107c1 and 107d1 of the baseplate 103 can be relieved unlike the configuration in which the edges of the cutouts disposed on the end 103c and the edges of the cutouts disposed on the end 103d are aligned in the Y direction.

### Second Embodiment

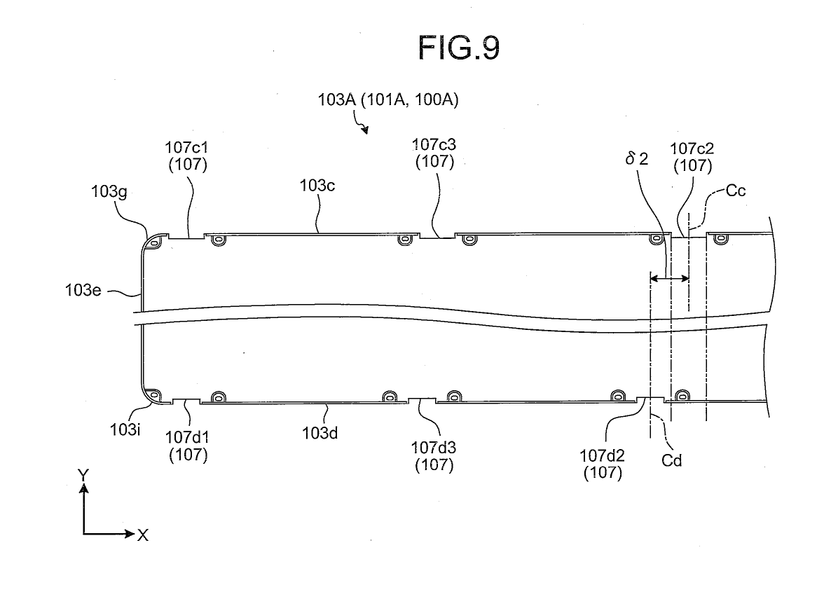

FIG. 9 is a partially enlarged view of a baseplate 103A included in a base 101A of a keyboard 100A according to a second embodiment. The keyboard 100A according to the second embodiment has the same or like configuration as the keyboard 100 according to the first embodiment. Hence, the second embodiment can also achieve the same actions and effects based from the same or like elements.

In the baseplate 103A, the cutouts 107c1, 107c2, and 107c3 are disposed on the end 103c while the cutouts 107d1, 107d2, and 107d3 are disposed on the end 103d. The number of the cutouts 107c1, 107c2, and 107c3 disposed on the end 103c is equal to the number of the cutouts 107d1, 107d2, and 107d3 disposed on the end 103d.

However, between the keyboard 100A and the keyboard 100, there is a difference of the offset in the X direction between the cutouts 107c1, 107c2, and 107c3 and the cutouts 107d1, 107d2, and 107d3. The offset δ2 between the cutouts 107c2 and the cutouts 107d2 in the X direction is relatively large and is equal to or greater than the width of the cutouts 107c2 and the cutouts 107d2, for example. In other words, the cutouts 107c2 and the cutouts 107d2 are out of alignment in the Y direction. In other words, the cutouts 107c2 and the cutouts 107d2 are (completely) offset in the X direction.

With such a configuration as the first embodiment, for example, in case the keyboard 100A is deformed by an external force or heat and in case the faces 101a and 101b of the base 101A are warped, that is, in case the faces 101a and 101b are warped concavely or convexly in the state that the central part in the X direction of the baseplate 103 and the ends 103e and 103f of the baseplate 103 are separated away in the Z direction, the concentration of stress in the vicinity of the cutouts 107c2 and 107d2 of the baseplate 103A can be relieved unlike the configuration in which the cutouts disposed on the end 103c and the cutouts disposed on the end 103d are aligned in the Y direction with no offset therebetween in the X direction. Moreover, since the number of cutouts 107c1, 107c2, and 107c3 is the same as the number of cutouts 107d1, 107d2, and 107d3, that is, the number of hooks 106 disposed on the end 101c of the base 101A is the same as the number of hooks 106 disposed on the end 101d of the base 101A, it becomes possible to reduce the difference in the spacing between the cutouts 107 on the end 103c and the cutouts 107 on the end 103d of the baseplate 103A. This can prevent a portion in one of the ends 103c, 103d lifting off easily from the housing 2.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Moreover, the configurations and the shapes can be partially interchanged among the embodiments and the modifications. Furthermore, the specifications about the configurations and the shapes (structure, type, direction, shape, size, length, width, thickness, height, number, arrangement, position, material, etc.) can be suitably modified. For example, the specifications of the cutouts such as the size of the cutouts, the number of the cutouts, the size of the offsets, the direction of the offsets are not limited to the embodiments described above.

What is claimed is:

1. A keyboard comprising:
a baseplate including a first end and a second end, the first end extending along a first direction, the second end extending along the first direction and being positioned opposite to the first end, a first cutout being disposed at the first end, a second cutout being disposed at the second end, the second cutout being aligned with the first cutout in a second direction with a partial offset in the first direction, the second direction intersecting the first direction;
a cover covering the baseplate, the cover including a third end and a fourth end, the third end extending along the first direction and being aligned with the first end in a third direction, the third direction intersecting the first direction and the second direction, the fourth end extending along the first direction and being aligned with the second end in the third direction, the third end and the fourth end including a first hooks, a part of the first hook being positioned within the first cutout or the second cutout; and
an operable key.

2. The keyboard according to claim 1, wherein
the baseplate includes a fifth end in the first direction and a sixth end in an opposite direction to the first direction,
the second cutout includes a third cutout and a fourth cutout, the third cutout being closer to the fifth end or the sixth end than to a center of the second end, and the fourth cutout being closer to a center of the second end than to the fifth end or the sixth end, and
the offset of the fourth cutout is greater than the offset of the third cutout.

3. The keyboard according to claim 1, comprising:
a wiring unit passing through a first opening disposed on the baseplate and extending along the baseplate on an opposite side of the cover, wherein
the wiring unit passes through between two of the first hook.

4. The keyboard according to claim 1, wherein
the number of the first hooks on the third end is equal to the number of the first hooks on the fourth end.

5. The keyboard according to claim 1, wherein
the second cutout includes a fifth cutout, the fifth cutout being aligned with the first cutout in the second direction, and
an edge of the fifth cutout in the first direction is out of alignment in the second direction with an edge of the first cutout in the first direction.

6. A keyboard comprising:
a baseplate including a first end and a second end, the first end extending along a first direction, the second end extending along the first direction and being positioned opposite to the first end, a first cutout being disposed on the first end, a second cutout being disposed at the second end, the second cutout being out of alignment with the first cutout in a second direction, and the second direction intersecting with the first direction;
a cover covering the baseplate, the cover including a third end and a fourth end, the third end extending along the first direction and being aligned with the first end in a third direction, the third direction intersecting the first direction and the second direction, the fourth end extending along the first direction and being aligned with the second end in the third direction, the third end and the fourth end including the same number of first hooks, a part of the first hook being positioned within the first cutout or the second cutout; and
an operable key.

7. An electronic device comprising:
the keyboard according to claim 1; and
a housing including a second hook, the second hook being disposed on a rim of a second opening, the second hook being hooked to the first hook, the second opening being disposed in the housing, the keyboard being housed in the second opening.

8. The electronic device according to claim 7, wherein
the baseplate includes a fifth end in the first direction and a sixth end in an opposite direction to the first direction,
the second cutout includes a third cutout and a fourth cutout, the third cutout being closer to the fifth end or the sixth end than to a center of the second end, and the fourth cutout being closer to a center of the second end than to the fifth end or the sixth end, and
the offset of the fourth cutout is greater than the offset of the third cutout.

9. The electronic device according to claim 7, comprising:
a wiring unit extending along the baseplate on an opposite side of the cover and passing through a hole disposed on the baseplate, wherein
the wiring unit passes through between two of the first hooks.

10. The electronic device according to claim 7, wherein
a number of the first hooks on the third end is equal to a number of the first hooks on the fourth end.

11. The electronic device according to claim 7, wherein
the second cutout includes a fifth cutout, the fifth cutout being aligned with the first cutout in the second direction, and
an edge of the fifth cutout in the first direction is out of alignment in the second direction with an edge of the first cutout in the first direction.

12. An electronic device comprising:
the keyboard according to claim 6; and
a housing including a second hook, the second hook being disposed on a rim of a second opening, the second hook being hooked to the first hook, the second opening being disposed in the housing, the keyboard being housed in the second opening.
